(19) United States
(12) Patent Application Publication
(10) Pub. No.: US 2014/0006274 A1
(43) Pub. Date: Jan. 2, 2014

(54) ELECTRONIC CARD RENDERING FOR MOBILE WALLET

(71) Applicants: David M. Grigg, Rock Hill, SC (US); Elizabeth S. Votaw, Charlotte, NC (US); Peter John Bertanzetti, Charlotte, NC (US); Matthew A. Calman, Charlotte, NC (US)

(72) Inventors: David M. Grigg, Rock Hill, SC (US); Elizabeth S. Votaw, Charlotte, NC (US); Peter John Bertanzetti, Charlotte, NC (US); Matthew A. Calman, Charlotte, NC (US)

(73) Assignee: BANK OF AMERICA CORPORATION, CHARLOTTE, NC (US)

(21) Appl. No.: 13/536,769

(22) Filed: Jun. 28, 2012

(51) Int. Cl. G06Q 20/36

(52) U.S. Cl. 705/41

(57) ABSTRACT

Embodiments of the invention include systems, methods, and computer-program products for providing electronic representations of the physical characteristics or affinity characteristics of payment devices on a mobile wallet. As such, the system may receive and/or request electronic illustrations of the physical characteristics of payment devices from a payment device supplier and store them in a database. Upon the user adding payment devices to his/her mobile wallet, the system may search the database to find matching electronic representations of the payment device. Upon matching, the user may receive the electronic representation at his/her mobile wallet. In this way, the user may visualize an exact representation of the actual physical characteristics of a payment device when the user is using a mobile wallet. Furthermore, the system may provide affinity data, such as ring tones, products, offers, clothing, or the like associated with the affinity of the payment device.

### BACKGROUND

Typically, individuals may shop on-line or at a merchant's place of business in order to purchase products he/she may want. When an individual finds the products that he/she wishes to purchase, the individual may purchase the product by tendering a payment device to the merchant. A payment device may typically include cash, credit cards, debit cards, gift cards, checks, or the like.

Recently, individuals have been giving the option of using a mobile wallet or e-wallet as a payment device. Mobile wallets store many of the individual's payment devices, such as credit cards, on a mobile device. The individual may present the mobile device as an alternative to the payment devices.

However, presenting a mobile wallet as a payment device requires an individual to input various payment devices onto his/her mobile wallet and subsequently select that payment device for use during the transaction. Inputting the various payment devices may include the individual manually inputting the payment device into the mobile wallet. In this way, the physical attributes of the payment device may not be visualized by the individual on his/her mobile wallet. Therefore, many individuals may have to take a closer look at his/her payment devices on his/her mobile wallet prior to selection the payment device.

Therefore, a need exists for a way to provide the physical characteristics or affinity characteristics of an individual's payment devices on a mobile wallet, such that the individual may be able to quickly recognize the payment device and it's affinity prior to using his/her mobile wallet for a purchase.

### BRIEF SUMMARY

Embodiments of the present invention address the above needs and/or achieve other advantages by providing apparatuses (e.g., a system, computer program product and/or other devices) and methods for providing physical characteristics or affinity characteristics of user payment devices to a user's mobile wallet or an online interface associated with financial accounts.

Embodiments of the present invention provide a mobile wallet or online interface of a user with the physical characteristics and/or affinity characteristics of a payment device.

In some embodiments, the system may receive data associated with payment devices from a payment device supplier. The data associated with the payment devices may include electronic versions of physical characteristics and/or affinity data. The physical characteristics may comprises the physical appearance of the payment device, such as the color, numbers, exposed chips, names, artwork, dates, codes, magnetic strips, signatures, lettering, trademarks, dates, logos, signs, symbols, or the like that may be displayed on the payment device. For example, a credit card's or debit card's physical appearance may include various colors, logos, numbers, names, dates, and the like on the front of the card and lettering, magnetic strips, or the like on the back of the card. The combination of these attributes make up the credit card's or debit card's physical characteristics. In another example, a credit card or debit card may be an affinity card. In this way, the card may comprise logos or trademarks associated with that affinity. As such, the physical characteristics of the credit card or debit card make up the physical characteristics of the payment device. The affinity data may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like.

In some embodiments, the system may request data associated with payment devices from a payment device supplier. In some embodiments, the system may pull data associated with payment devices from a payment device supplier. In yet other embodiments, the system may receive data associated with payment devices automatically from a payment device supplier.

Once the system receives the electronic versions of the physical characteristics and/or affinity data associated with payment devices from the payment device supplier, the data may be stored in a database. The database may associate the physical characteristics and/or affinity data with each available payment device. For example, Credit Card 1 from Brand 1 may have specific physical characteristics and/or affinity data associated with it. However, Credit Card 2 from Brand 1 may have completely different physical characteristics and/or affinity data associated therewith. In this way, the database may store all physical characteristics and/or affinity data associated with each payment device that a user may input into his/her mobile wallet.

In some embodiments, the system may receive an indication that a user is inputting one or more payment devices into a mobile wallet. A mobile wallet may be any type of digital wallet that may be an alternative payment method using a mobile device to pay for a product. Mobile wallets allow a user to make electronic commerce transactions via his/her mobile device quickly and securely. In some embodiments, the user may manually input the payment devices into his/her mobile wallet. In other embodiments, the payment devices may be automatically inputted into his/her mobile wallet. In this way, the mobile wallet may include account numbers, names, expiration dates, or the like that are associated with the payment device. For example a user may input Credit Card 1 onto his/her mobile wallet. The information stored in the mobile wallet may include only the information necessary to make a payment using Credit Card 1. As such, the account number, expiration date, security code, name, and the like may be presented. However, typically, the physical characteristics and/or the affinity data associated with Credit Card 1 may not be transferred to the mobile wallet.

In some embodiments, the system may receive an indication that a user is inputting one or more payment devices into his/her online banking interface. An online banking interface may comprise online statements, balances, and the like associated with a payment device of the user. In some embodiments, the user may manually input the payment devices into his/her online banking interface. In other embodiments, the payment devices may be automatically inputted into his/her online banking interface. In this way, the online banking interface may include account numbers, names, expiration dates, or the like that are associated with the payment device. However, typically, the physical characteristics and/or the affinity data associated with payment devices may not be illustrated on the user's online banking interface.

Once the system receives an indication that a user is inputting one or more payment devices onto his/her mobile wallet or onto his/her online banking interface, the system may determine the type of payment device the user is inputting. At this point, the system may search the database to match the inputted payment device with payment device data stored on the database. The data stored on the database, as discussed above, includes electronic illustrations of physical characteristics and/or affinity data associated with payment devices. In some embodiments, the inputted payment device may be matched with payment device data stored on the database. In some embodiments, the inputted payment device may not match any payment device data stored on the database. In this way, the system may, using the information the user inputted about the payment device, communicate with payment device suppliers to retrieve the physical characteristics and/or affinity data for the inputted payment device.

In some embodiments, once a match is determined, the system may provide the user with an electronic representation of the physical characteristics of the payment device. In some embodiments, the electronic representation may be presented to the user's mobile wallet. In some embodiments, the electronic representation may be presented to the user's online banking interface. In some embodiments, the system may provide the user with affinity data associated with the payment device. The electronic representation of the physical characteristics of the payment device is an electronic representation of the actual physical appearance of the payment device, such as the color, numbers, exposed chips, names, artwork, dates, codes, magnetic strips, signatures, lettering, trademarks, dates, logos, signs, symbols, or the like. For example, the user may have inputted Credit Card 1 into his/her mobile wallet. Credit Card 1 may be from Brand 1, as such Credit Card 1 may have Brand 1 logo on the front of it. Furthermore, Credit Card 1 may have a physical appearance with blue and white stripes. As such, the electronic representation of Credit Card 1 on the user's mobile wallet may match the same physical appearance as the physical Credit Card 1. In this way, the user may quickly recognize the payment device based on physical appearance and select that payment device for use during a mobile wallet transaction.

In some embodiments, the system may provide the user with affinity data associated with the payment device. The affinity data may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like. The affinity data may be provided to the user via a mobile device, the mobile wallet, email, social media, text message, standard mail, audio message, and/or the like. As such, the electronic representation of the payment device associated with the user's mobile wallet may include any affinity data associated with that payment device.

Furthermore, in some embodiments, affinity data may be provided to the user in addition to or separate from the electronic representation of the payment device. In this way, ancillary affinity data such as music, theme songs, ring tones, wallpaper, offers, affinity paraphernalia, such as clothing, or the like, alternative colors, alternative logos, or the like may be presented to the user. This ancillary affinity data may, in some embodiments, be directly linked to the payment device associated with the mobile wallet. In other embodiments, the ancillary affinity data may be provided independently of the payment device associated with the mobile wallet. In this way, once the system recognizes and provides the mobile wallet with the affinity data associated with a payment device, the system may subsequently provide the user with various ancillary affinity data.

In this way, the system may present and/or allow for electronic presentment of the physical characteristics and affinity data associated with any payment device on to a mobile wallet. In this way, the user may visualize the physical appearance of payment device, electronically on his/her mobile wallet or online banking interface, the same way he/she would if he/she was using the payment device itself for payment for a transaction.

Embodiments of the invention relate to systems, methods, and computer program products for providing electronic representation of payment devices at a mobile wallet, the invention comprising: receiving an indication that a user is adding a payment device to the mobile wallet, wherein information is received related to the added payment device such that the added payment device can be used for a transaction using the mobile wallet; identifying the added payment device based at least in part on information associated with the added payment device, wherein the information associated with the added payment device is provided by the user to the mobile wallet; searching a payment device database for a match between the added payment device and a payment device on the payment device database, wherein the payment device database comprises stored electronic representation of physical characteristics of payment devices; determining affinity data associated with the added payment device; providing the user with the electronic representation of the physical characteristics of the added payment device, such that the electronic representation of the physical characteristics of the added payment device are displayed in association with the mobile wallet; and providing, upon the determination of affinity data associated with the added payment device, the user with the affinity data.

In some embodiments, providing the user with the affinity data further comprises providing the user with one or more of ring tones, wallpaper, logos, or applications associated with the affinity provided at a user's mobile device. In other embodiments, providing the user with the affinity data further comprises providing the user with offers and products associated with the affinity, wherein the user receives the affinity data by inputting the payment device associated with the affinity into the mobile wallet. In some embodiments, determining affinity data associated with the added payment device further comprises determining entities associated with the added payment device that provide one or more incentives to the user for using the added payment device.

In some embodiments, the invention further comprises establishing the payment device database by requesting electronic representations of the physical characteristics of payment devices and affinity data associated therewith from a payment device supplier.

In some embodiments, identifying the payment device being added is based at least in part on information associated with the added payment device provided by the user to the mobile wallet, wherein the information associated with the added payment device includes an account number, name, and expiration date associated with the payment device.

In some embodiments, the invention further comprises matching the added payment device to stored electronic representation of physical characteristics of payment devices on the payment device database based on the information associated with the added payment device, such that an electronic representation of the physical characteristics of the added payment device is determined. In some embodiments, if no match between the added payment device and stored electronic representation of physical characteristics of payment devices on the payment device database is identified the processing device can request the electronic representation of the physical characteristics of the added payment device from the payment device supplier.

In some embodiments, the electronic representation of the physical characteristics of the added payment device include representation of one or more of colors, logos, numbers, magnetic strips, or chips associated with the physical appearance of the added payment device, as such the electronic representation of the physical characteristics of the added payment device match the physical appearance of the added payment device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating an electronic payment device rendering method for providing the physical and affinity characteristics of a payment device to a mobile wallet, in accordance with one embodiment of the present invention;

FIG. 2 provides an electronic payment device rendering system environment, in accordance with one embodiment of the present invention;

FIG. 3 provides a process map illustrating a system process of providing electronic payment device rendering, in accordance with one embodiment of the present invention;

FIG. 4 provides a process map illustrating a system process of providing electronic rendering of credit cards at a mobile wallet, in accordance with one embodiment of the present invention;

FIG. 5 provides a process map illustrating a user process for receiving electronic renderings of payment devices at a mobile wallet, in accordance with one embodiment of the present invention; and

FIG. 6 provides an interface illustrating the electronic rendering of payment devices at a mobile wallet, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. A “payment device” as used herein may refer to any means of payment for a product of a transaction. As such a payment device may include, but is not limited to a credit card, debit card, currency, paper money, coin money, lines of credit, gift cards, checks, virtual currency, electronic payment means, or the like. A “merchant” as used herein may refer to a manufacturer, retailer, service provider, event provider, warehouse, supplier, and/or the like. Furthermore, as used herein, the term “product” shall mean any good, service, event, or the like that may be offered by a merchant.

Further, the embodiments described herein may refer to use of a transaction or transaction event. Unless specifically limited by the context, a “transaction” refers to any communication between the user and a merchant, financial institution, or other entity. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal. In still further embodiments, a transaction may refer to an event and/or action or group of actions facilitated or performed by a user's device, such as a user's mobile system, a merchant system, and/or a combination thereof.

Some portions of this disclosure are written in terms of a financial institution's unique position with respect to payment device suppliers, such as merchants, credit companies, other financial institutions, or the like. As such, a financial institution may be able to utilize its unique position to provide physical and affinity data associated with payment devices to a user that wishes to have an electronic rendering of that payment device within his/her mobile wallet or other electronic payment means. Furthermore, portions of this disclosure are written in terms of an electronic card rendering for a mobile wallet. The disclosure may also include electronic card renderings for an online banking interface. As such, the disclosure may be for one of or both mobile wallet or an online banking interface.

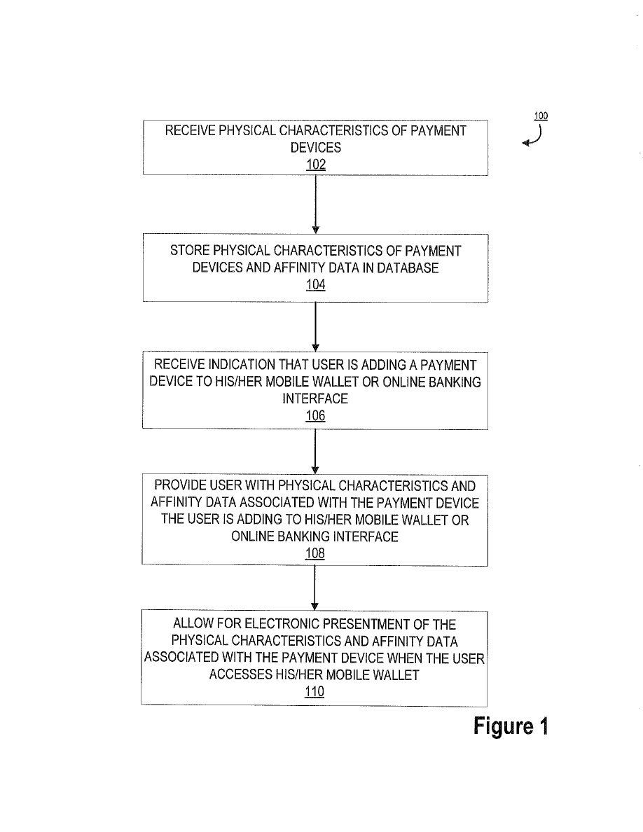

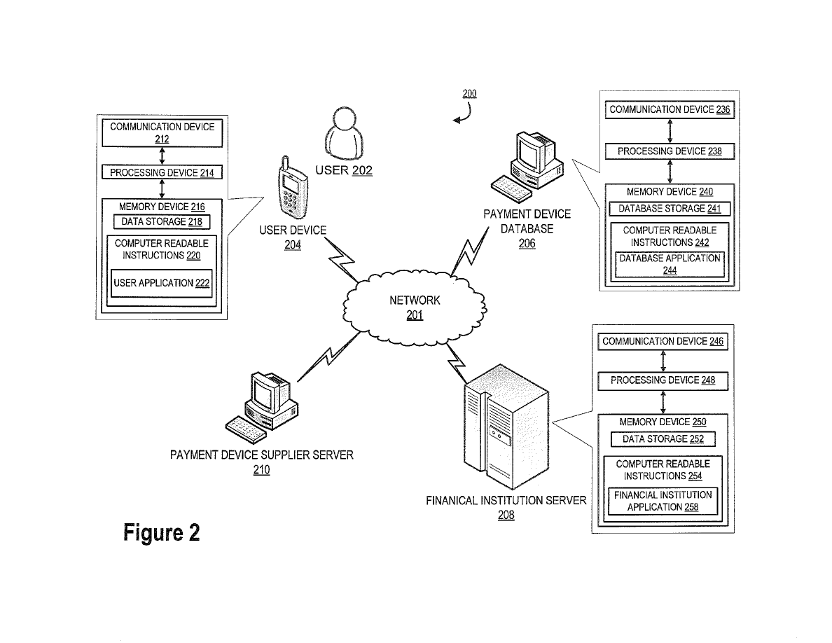

FIG. 1 provides a high level process flow illustrating an electronic payment device rendering method for providing the physical and affinity characteristics of a payment device to a mobile wallet 100, which will be discussed in further detail throughout this specification with respect to FIGS. 2 through 6. The first step in the process 100, as illustrated in block 102 is receiving data associated with the physical characteristics of a payment device. The physical characteristics include any feature of the payment device that makes up the payment device's physical appearance. This may be, but is not limited to the color, numbers, paper type, exposed chips, names, artwork, dates, codes, magnetic strips, signatures, lettering, trademarks, dates, logos, signs, symbols, or the like that may be displayed on the payment device.

In some embodiments, the physical characteristics may be received from payment device suppliers. In some embodiments, the physical characteristics may be received from the user. In some embodiments, the physical characteristics may be determined by the financial institution.

Next, as illustrated in block 104, the system may store electronic representations of physical characteristics of the payment devices in a database. The physical characteristics may be stored by payment device type, payment device supplier, account number, name, or the like. Furthermore, the system may also store any affinity data associated with the payment device. Affinity data may include any data associated with an entity affinity for the payment device. An affinity may be an entity, such as a sports team, school, business, merchant, organization, product, or the like that may provide a branding, logo, color, trademark, or the like to the payment device, such that the affinity is displayed on the physical payment device. The affinity data may also include ancillary affinity data such as music, theme songs, ring tones, offers, alternative colors, alternative logos, or the like. The physical appearance of the payment device, as such, may show a close similarity in appearance or quality, an inherent likeness, or a similarity in nature to the branding commonly known to be associated with the affinity entity. The affinity data may be stored in connection with the physical characteristics of the payment device.

Next, as illustrated in block 106, the system may receive an indication that a user is adding a payment device to his/her mobile wallet and/or his/her online interface. The indication may be received by communication from the user's mobile wallet. Once the system receives an indication that a user is adding a payment device to his/her mobile wallet or online banking interface, the system may determine the payment device that is being added. As such, the system may determine if the database has physical and/or affinity data for that particular payment device being added. In some embodiments, the database may have the physical and/or affinity data associated with the added payment device. In other embodiments, the database may not have the physical and/or affinity data stored within it. As such, the system may request the physical and/or affinity data from the payment device supplier. In this way, the database may be able to provide the user with physical and/or affinity data associated with any payment device associated with a mobile wallet or online banking interface of a user.

Once a match has been made between the payment device that the user is added and the physical and/or affinity data associated with that payment device, as illustrated in block 108, the user may be provided with the physical and/or affinity data associated with the payment device the user is adding to his/her mobile wallet. In this way, the physical and/or affinity data may be presented in an electronic representation of the physical attributes of the payment device to the user via his/her mobile wallet. As such, as illustrated in block 110, when the user accesses his/her mobile wallet, the system may allow for electronic presentment of the physical and/or affinity data associated with the payment devices on the user's mobile wallet.

FIG. 2 provides an electronic payment device rendering system environment 200, in accordance with one embodiment of the present invention. As illustrated in FIG. 2, the financial institution server 208 is operatively coupled, via a network 201 to the user device 204, the payment device database 206, and the payment device supplier server 210. In this way, the financial institution server 208 can send information to and receive information from the user device 204, payment device database 206, and the payment device supplier server 210 to provide physical characteristics and affinity data associated with payment devices to a user's mobile wallet, such to provide electronic payment device rendering to the user. FIG. 2 illustrates only one example of an embodiment of an electronic payment device rendering system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual making a transaction, such as a financial transaction. The transaction may be made at a point-of-transaction (POT) of a merchant, online or offline, at the merchant's place of business and/or other transaction means. The purchase may be made by the user 202 using any type of payment device available to the user 202, such as, but not limited to cash, credit cards, debit cards, gift cards, checks, lines-of-credit, or the like. Furthermore, the user 202 may use his/her user device 204 as a mobile wallet or other types of payment system that may communicate with a POT to allow the user 202 to complete a transaction. Furthermore, in some embodiments, the user 202 may be a merchant or a person, employee, agent, independent contractor, or the like acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the payment device database 206, the payment device supplier server 210, and the user device 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the financial institution application 258 including but not limited to data created and/or used by the financial institution application 258.

In the embodiment illustrated in FIG. 2 and described throughout much of this specification, the financial institution application 258 allows for the presentation of electronic representation of physical characteristics and/or affinity data of a payment device on a mobile wallet of a user 202. As such, the financial institution application 258 may retrieve physical characteristics of payment devices, retrieve affinity data of payment devices, store physical characteristics and/or the affinity data associated with payment devices, receive indications that the user 202 has added a payment device to his/her mobile wallet, determine user 202 added payment device type, match the stored data with the added payment device, communicate the physical characteristics of the added payment device to a user 202 mobile wallet, communicate the affinity data to the user 202, and allow for presentment of the physical characteristics and/or the affinity data.

In some embodiments, the financial institution application 258 may retrieve data associated with payment devices from a payment device supplier. In this way, the system may interact with a payment device supplier. Furthermore, the system may receive access or usage value from the payment device supplier for allowing the electronic rendering of the payment device on the user's mobile wallet or online banking interface. This value may be a one-time value, installment value, or the like. In some embodiments the financial institution application 258 may retrieve data associated with payment devices from a user 202. In some embodiments, the financial institution application 258 may retrieve electronic data associated with payment devices from a financial institution. In some embodiments, the financial institution application 258 may request data. In other embodiments, the financial institution application 258 may receive data without a specific request for it. The data associated with the payment devices that may be retrieved may include electronic representations of the physical characteristics and/or affinity data on the mobile wallet and/or online banking interface.

The electronic representation of the physical characteristics may comprises the physical appearance of the payment device, such as the color, numbers, exposed chips, names, artwork, dates, codes, magnetic strips, signatures, lettering, trademarks, dates, logos, signs, symbols, or the like that may be displayed on the payment device. For example, a credit card's or debit card's physical appearance may include various colors, logos, numbers, names, dates, and the like on the front of the card and lettering, magnetic strips, or the like on the back of the card. The combination of these attributes make up the credit card's or debit card's physical characteristics. In another example, a credit card or debit card may be an affinity card. In this way, the card may comprise logos or trademarks associated with that affinity. As such, the physical characteristics of the credit card or debit card make up the physical characteristics of the payment device.

The affinity data may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like.

The financial institution application 258 may then store the electronic representations of the physical characteristics and/or the affinity data associated with the received payment devices in a database, such as the payment device database 206. The database may associate the physical characteristics and/or affinity data with each available payment device. In this way, the database may store all data searchable via payment device type, account number type, payment device supplier name, or the like. Furthermore, the database may also be searchable by the financial institution application 258 to find physical attributes, such as color, logo, font, or the like associated with a payment device. In this way, the database may store all physical characteristics and/or affinity data associated with each payment device received from a payment device supplier, such that the financial institution application 258 may easily access and search the database quickly for individual payment devices and that payment device's physical characteristics and/or affinity data.

In some embodiments, the financial institution application 258 may then receive an indication that a user 202 is adding a payment device to his/her mobile wallet. A mobile wallet may be any type of digital wallet that may be an alternative payment method using a mobile device to pay for a product. Mobile wallets allow a user 202 to make electronic commerce transactions via his/her mobile device quickly and securely. In some embodiments, the user 202 may manually input the payment devices into his/her mobile wallet. In other embodiments, the payment devices may be automatically inputted into the user's mobile wallet. In this way, the mobile wallet may include account numbers, names, expiration dates, or the like that are associated with the payment device. Typically, when a user 202 inputs a payment device into his/her mobile wallet information regarding the payment device is stored in the mobile wallet. The information stored in the mobile wallet may include only the information necessary to make a payment for a product at a merchant using the payment device. As such, the account number, expiration date, security code, name, and the like may be presented. However, typically, the physical characteristics and/or the affinity data associated with Credit Card 1 may not be transferred to the mobile wallet.

In some embodiments, the financial institution application 258 may then receive an indication that a user 202 is inputting one or more payment devices into his/her online banking interface. An online banking interface may comprise online statements, balances, and the like associated with a payment device of the user. In some embodiments, the user 202 may manually input the payment devices into his/her online banking interface. In other embodiments, the payment devices may be automatically inputted into his/her online banking interface. In this way, the online banking interface may include account numbers, names, expiration dates, or the like that are associated with the payment device. However, typically, the physical characteristics and/or the affinity data associated with payment devices may not be illustrated on the user's online banking interface.

The financial institution application 258 may receive this indication via communication from a user device 204 to the financial institution server 208 via a network 201. In some embodiments, the indication of the addition of a payment device may be pulled from the user's mobile wallet. In some embodiments, the user 202 may push the indication of the addition of a payment device to the financial institution application 258. In some embodiments, this indication may be provided manually by the user 202 of the mobile wallet. In other embodiments, the financial institution application 258 may automatically receive the indication.

Once the financial institution application 258 recognizes that a user 202 has added a payment device to his/her mobile wallet or online banking interface, the financial institution application 258 may determine the specific type of payment device added. In this way the financial institution application 258 may determine the type, brand, or the like of the payment device added. The information, such as the account number, expiration date, serial numbers, codes, monetary amount, or the like that may be inputted onto the mobile wallet by the user 202 may provide the financial institution application 258 with the data necessary to recognize the exact payment device the user 202 may be adding to his/her mobile wallet or online banking interface. For example, the specific payment device may be determined by the account numbers associated with that payment device. These payment devices, such as a credit card, debit card, or the like may have account numbers that are specific to Brand 1 credit cards. Furthermore, the account numbers for Brand 1 credit cards may also have account numbers that are specific to not only the brand, but also the specific credit card of Brand 1. In some embodiments, the financial institution application 258 may determine the specific type of payment device added to the user's mobile wallet automatically. In other embodiments, the financial institution application 258 may determine the specific type of payment device added to the user's mobile wallet via user 202 manual input.

Next, after the financial institution application 258 has determined the specific type of payment device the user 202 has inputted into his/her mobile wallet, the financial institution application 258 may match the specific payment device with the data stored on the payment device database 206. The data stored on the payment device database 206 includes physical characteristics and/or affinity data associated with payment devices. In some embodiments, the inputted payment device may be matched with payment device data stored on the payment device database 206. In this way the financial institution application 258 may search the payment device database 206 for the physical characteristics and/or affinity data stored thereon that is associated with the payment device inputted by the user 202. The specific payment device that was inputted by the user 202, once determined, may be utilized by the financial institution application 258 to search the payment device database 206 for the physical characteristics and/or affinity data associated with that payment device. The financial institution application 258 may use any obtained information about the inputted payment device to search the payment device database 206, such as, but not limited to account numbers, determined brand, determined type, names, expiration dates, and/or any other identifiable information associated with the payment device that the user 202 may have inputted onto his/her mobile wallet. In some embodiments, using this information the financial institution application 258 may be able to search the payment device database 206 to find one or more matches between the information from the inputted payment device and the physical characteristics and/or affinity data associated with payment devices stored on the payment device database 206.

In some embodiments, the inputted payment device and the information determined therefrom may not match to any physical characteristics and/or affinity data for payment devices stored on the payment device database 206. In this way, the financial institution application 258 may, using the payment device information the user 202 inputted about the payment device, communicate with payment device suppliers server 201 to retrieve the physical characteristics and/or affinity data for the inputted payment device.

Once the financial institution application 258 determines a match between the inputted payment device and physical characteristics and/or affinity data stored within the payment device database 206, the financial institution application 258 may communicate the physical characteristics and/or affinity data to a user 202. In some embodiments the financial institution application 258 may communicate the physical characteristics associated with the inputted payment device to the user's mobile wallet. In some embodiments, the financial institution application 258 may communicate the affinity data associated with the inputted payment device to the user 202. In some embodiments, the financial institution application 258 may communicate both physical characteristics and affinity data associated with the inputted payment device to the user 202.

In some embodiments, once a match is determined, the financial institution application 258 may provide the user 202, via his/her mobile wallet, with an electronic representation of the physical characteristics of the payment device the user 202 inputted into his/her mobile wallet. The electronic representation of the physical characteristics of the payment device is an electronic representation of the actual physical appearance of the payment device, such as the color, numbers, exposed chips, names, artwork, dates, codes, magnetic strips, signatures, lettering, trademarks, dates, logos, signs, symbols, or the like associated with the payment device stored on the payment device database 206. For example, the user may have inputted Credit Card 1 into his/her mobile wallet. Credit Card 1 may be from Brand 1, as such Credit Card 1 may have Brand 1 logo on the front of it. Furthermore, Credit Card 1 may have a physical appearance with blue and white stripes. As such, the electronic representation of Credit Card 1 on the user's mobile wallet may match the same physical appearance as the physical Credit Card 1. In this way, the user 202 may quickly recognize the payment device based on physical appearance and select that payment device for use during a mobile wallet transaction.

In some embodiments, once a match is determined, the financial institution application 258 may provide the user 202 with affinity data associated with the payment device the user 202 may have inputted onto his/her mobile device. The affinity data may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like. The affinity data may be provided to the user 202 via communication with the user device 204, the user device 204 mobile wallet, email, social media, text message, standard mail, audio message, and/or the like. As such, the user 202 may be able to utilize affinity data associated with the payment device. For example, the user 202 may receive ring tones for his/her user device 204, such as a fight song, or the like associated with the affinity of the payment device. In another embodiment, the user 202 may receive offers, discounts, or promotions associated with an affinity merchant associated with the payment device. In this way, the user 202, after selecting an affinity for a payment device in the past, may now also receive other ancillary affinity benefits such as offers, music, theme songs, ring tones, clothing, merchandise, or the like associated with that affinity. In some embodiments, the ancillary affinity benefits may be offers or the like for various merchants associated with the affinity. This ancillary affinity data may, in some embodiments, be directly linked to the payment device associated with the mobile wallet. In other embodiments, the ancillary affinity data may be provided independently of the payment device associated with the mobile wallet. In this way, once the financial institution application 258 recognizes and provides the mobile wallet with the affinity data associated with a payment device, the financial institution application 258 may subsequently provide the user 202 with various ancillary affinity data. The ancillary affinity data may be received by the financial institution application 258 from the payment device supplier servers 210 via commination over a network 201.

Furthermore, the affinity benefits, both ancillary and/or standard affinity benefits may be, in some embodiments, presented to the user 202 in a build-up fashion at his/her mobile wallet and/or online banking interface. For example, the more times the user 202 uses his/her affinity the more affinity benefits the user 202 may receive (e.g. the longer, higher quality, higher value, or the like). For example, the user 202 may receive an ancillary affinity benefit of a fight song associated with his/her favorite college. Initially, the user 202 may only receive a toned version or partial version of the fight song. However, after built-up of use or the like, the user 202 may receive the entire fight song performed by the marching band as opposed to a toned version.

Finally, the financial institution application 258 may allow for presentment of the physical characteristics and/or the affinity data associated with the inputted payment device. In this way, the financial institution application 258 may present and/or allow for electronic presentment of the physical characteristics and affinity data associated with any payment device on to a mobile wallet. The user 202 may visualize the physical appearance of payment device, electronically on his/her mobile wallet, the same way he/she would if he/she was using the payment device itself for payment for a transaction. The user 202 may also receive affinity data and/or ancillary affinity data, in some embodiments, via communication with a user device 204 over a network 201. In some embodiments, the affinity data and/or ancillary affinity data may be communicated to the user 202 any various other electronic and/or non-electronic means, such that the user 202 may receive affinity data and/or ancillary affinity data associated with the payment device.

In this way, the financial institution application 258 allows the user 202 to visualize an electronic representation of the specific physical attributes associated with each of the payment devices on the user's mobile wallet. As such, the user 202 may be able to visualize Credit Card 1 the same on his/her mobile wallet as he/she would using the physical card of Credit Card 1 for a transaction. In another example, cash, no matter the currency, that may be associated with a user's mobile wallet may be shown as an electronic form on the mobile wallet. As such, the amount of cash associated with the mobile wallet may also be displayed electronically on the mobile wallet.

As illustrated in FIG. 2, the payment device database 206 may include a communication device 236 to communicate with the other systems such as, but not limited to the user device 204, financial institution server 208, and/or the payment device supplier server 210 over a network 201. As such, the communication device 236 generally comprises a modem, server, or other device for communicating with other devices on the network 201.

The payment device database 206 primarily functions as a storage database for all of the obtained physical characteristics and/or affinity data associated with payment devices. As such, the payment device database 206 may store physical characteristics and/or affinity data associated with payment devices, as well as any information necessary to identify the physical characteristics and/or affinity data stored on the payment device database 206. This identification information may include any data associated with a payment device that a user 202 may provide to his/her mobile wallet, such as, but not limited to account numbers, expiration dates, payment device type, or the like. As such, the payment device database 206 may be able to store physical characteristics and/or affinity data that may be able to be searched for and found via searching the payment device database 206 using these identification information.

As further illustrated in FIG. 2, the payment device database 206 comprises computer-readable instructions 242 stored in the memory device 240, which in one embodiment includes the computer-readable instructions 242 of a database application 244.

In the embodiment illustrated in FIG. 2, the database application 244 allows the payment device database 206 to receive, request, store, and provide physical characteristics and/or affinity data of a payment device for electronic presentment on a user's mobile wallet. As such, the database application 244 may be communicably linked to the financial institution server 208 and other devices on the network 201 to communicate, via a network 201, information associated with payment devices to allow for the electronic presentment of the physical characteristics and/or affinity data associated with the payment device to a user 202 via his/her mobile wallet.

In some embodiments, the database application 244 may receive an electronic version of the physical characteristics and/or affinity data associated with payment devices. In this way, the database application 244 may receive any physical characteristics and/or affinity data associated with any type of payment device. In this way, when the financial institution server 208 requests and/or searches the payment device database 206, the payment device database 206 may have stored the majority of possible payment devices that would be added to a mobile wallet by a user 202. In some embodiments, the physical characteristics and/or affinity data may be received from the payment device supplier via the payment device supplier server 210 communication via a network 201 to the payment device database 206. In some embodiments, the physical characteristics and/or affinity data may be received from the user 202 thought user device 204 communication via a network 201 to the payment device database 206. In some embodiments, the physical characteristics and/or affinity data may be received by the database application 244 from other entities or individuals.

In some embodiments, the database application 244 may request physical characteristics and/or affinity data. In this way, the database application 244 may receive a request for physical characteristics and/or affinity data from the financial institution server 208 that the database application 244 may not have stored in the payment device database 206. The database application 244 may be able to communicate, via the communication device 236 through a network 201 to one or more other systems to request the physical characteristics and/or affinity data associated with a payment device. Specifically, the database application 244 may communicate with payment device supplier servers 210 to request the physical characteristics and/or affinity data associated with the payment device added by the user 202.

In some embodiments, the database application 244 may store the physical characteristics and/or affinity data for all payment devices. The physical characteristics and/or affinity data may be stored in the database storage 241. The physical characteristics and/or affinity data may be stored in a searchable manner, such that any information provided by a user 202 adding a payment device to his/her mobile wallet may be used to search the payment device database 206. The physical characteristics stored in the payment device database 206 may comprises the physical appearance of the payment device, such as the color, numbers, exposed chips, names, artwork, dates, codes, magnetic strips, signatures, lettering, trademarks, dates, logos, signs, symbols, or the like that may be displayed on the payment device. The affinity data stored in the payment device database 206 may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like.

Finally, the database application 244 may provide the electronic representation of the physical characteristics and/or affinity data of a payment device to the financial institution server 208, in order to provide an electronic representation of the same to a user's mobile wallet.

FIG. 2 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the payment device database 206, payment device supplier server 210, and the financial institution server 208. As such, the communication device 212 generally comprises a modem, server, or other device for communicating with other devices on the network 201.

As further illustrated in FIG. 2, the user device 204 comprises computer-readable instructions 220 stored in the memory device 216, which in one embodiment includes the computer-readable instructions 220 of a user application 222. In this way, the user application 222 allows a user 202 to have and/or support a mobile wallet and/or online banking interface. A “user device” 204 may be any mobile communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 2, the system environment 200 may contain numerous user devices 204.

In some embodiments, the user application 222 allows a user 202 to utilize his/her mobile device 204 as a mobile wallet to use for purchase of a transaction at a point-of-transaction (POT) or as an access point to access his/her online banking interface. As such, the user application 222 may provide information about user 202 added payment devices to the financial institution server 208, receive electronic rendering of the physical characteristics and/or affinity data associated with the payment device, and allow the user 202 to utilize the user device 204 as a mobile wallet for transactions at a POT.

The user application 222 may allow a user 202 to add payment devices to his/her mobile wallet or online banking interface. As such, the user application 222 may provide information associated with the added payment devices to the system, such that the user 202 may be able to later receive electronic representations of the payment devices the user 202 has added. The user device 204 may communicate the information associated with the added payment device via the communication device 212 through a network 201 to the financial institution server 208 and/or the payment device database 206.

The user application 222 may also receive the electronic rendering of the physical characteristics and/or affinity data associated with the payment device the user 202 added. The electronic rendering of the physical characteristics and/or affinity data associated with the payment device may be provided from the financial institution server 208 to the user's user device 204 such that the user may visualize an electronic representation of the payment devices that the user 202 may utilize during a transaction. The electronic representation may be the same or be similar to the visualization the user 202 may receive when he/she uses the real payment device. In this way, the electronic representation of the payment device may allow a user 202 to quickly view the payment devices available to him/her and allow him/her to quickly select the appropriate payment device based on visualization.

Finally, the user application 222 allow the user 202 to utilize the user device 204 as a mobile wallet for transactions at a POT and/or as an access for the user's online banking interface. In this way, the user 202 may use his/her user device 204 to purchase a product and the like at a POT using a payment device that he/she may have using an electronic means, such as a mobile wallet.

FIG. 2 also illustrates a payment device supplier server 210. The payment device supplier server 210 is operatively coupled to the financial institution server 208, user device 204, and/or the payment device database 206 through the network 201. The payment device supplier server 210 has systems with devices the same or similar to the devices described for the financial institution server 208, user device, and/or the payment device database 206 (i.e., communication device, processing device, and memory device). Therefore, the payment device supplier server 210 may communicate with the financial institution server 208, user device 204, and/or the payment device database 206 in the same or similar way as previously described with respect to each system. The payment device supplier server 210, in some embodiments, is comprised of systems and devices that allow for receiving and sending electronic illustrations of physical characteristics and/or affinity data associated with each of the one or more payment devices supplied by the payment device supplier associated with the payment device supplier server 210. In this way, the financial institution application 258 may be able to access electronic representations of all of the payment devices supplied by the payment device supplier such that the financial institution application 258 may have access to all electronic renderings of the physical characteristics and/or affinity data associated with the payment devices.

It is understood that the servers, systems, and devices described herein illustrate one embodiment of the invention. It is further understood that one or more of the servers, systems, and devices can be combined in other embodiments and still function in the same or similar way as the embodiments described herein.

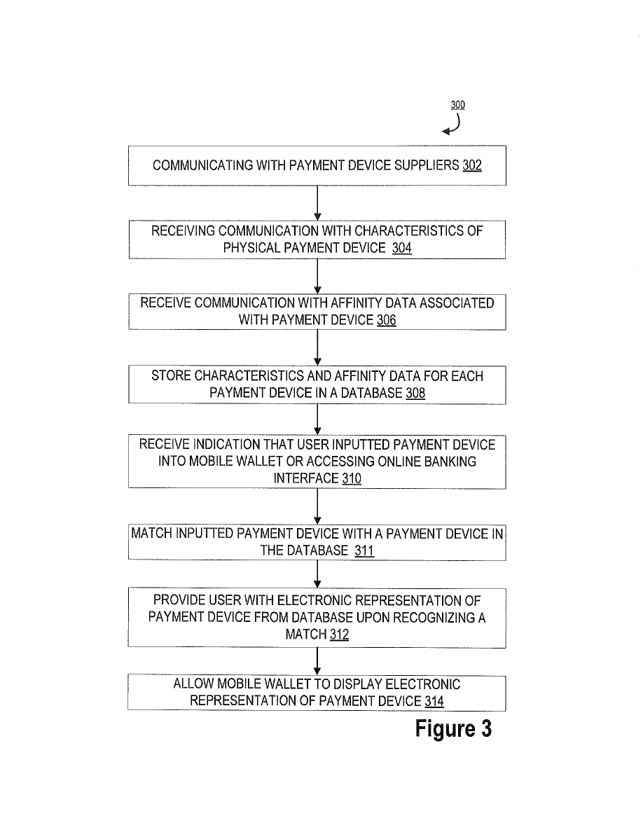

FIG. 3 illustrating a process map of a system process of providing electronic payment device rendering 300, in accordance with one embodiment of the present invention. As illustrated in block 302, the process 300 is initiated by the system communicating with the various payment device suppliers. This communication linkage allows the system to send requests for and receive data from the payment device suppliers. In this way, the payment device suppliers may send the system electronic data that includes electronic representations the physical appearance of the payment device. For example, if the physical payment device is a check, the payment device supplier may sent the system an electronic representation of that check, such as the colors, logos, names, numbers, lines, address, or the like that may be located on the physical check itself. In this way, the system may be able to receive an exact electronic representation of the physical check.

In some embodiments, the payment device supplier may include, but is not limited to a financial institution, credit card provider, entity, merchant, supplier, or the like. Furthermore, the payment device supplier may also be the user 202 who is inputting the payment device onto his/her mobile wallet or online banking interface and take electronic representations of that payment device, such as taking a photo, image, or the like of the payment device.

Next, as illustrated in block 304, the system may receive the electronic representations of the physical characteristics of the payment device. As such, the system may receive electronic representations of all types of payment devices, whether the system requested the data or the system simply received the data from the payment device supplier. The physical characteristics may comprises the physical appearance of the payment device, such as the color, numbers, exposed chips, names, artwork, dates, codes, magnetic strips, signatures, lettering, trademarks, dates, logos, signs, symbols, or the like that may be displayed on the payment device. In this way, the electronic representation of the physical characteristics of the payment device will provide the user 202 with an exact electronic representation of the payment device. For example, the user 202 may have Debit Card 1 that is a specific size, shape, color, or the like. The electronic representation of the Debit Card 1 may provide these same physical attributes, such that the electronic representation may match the actual Debit Card 1 in size, shape, color, or the like The system may also receive affinity data associated with the payment devices, as illustrated in block 306. The affinity data may include, but is not limited to logos, trademarks, mascots, colors, figures, symbols, or the like associated with the affinity. The affinity data may also include ancillary affinity data such as music, theme songs, ring tones, offers, alternative colors, alternative logos, or the like.

Once the system receives the electronic representation of the physical characteristics and/or the affinity data associated with the payment device, the system may, as illustrated in block 308, store the physical characteristics and affinity for each payment device in a database. In this way, the physical characteristics and/or affinity data for each payment device may be stored in a searchable fashion such that the physical characteristics and/or affinity data may be found for each payment device upon searching for that payment device using any identification means. The system may, for example, be able to search the database based on identification means such as names, account numbers, colors, brands, payment device types, or the like.

Next, as illustrated in block 310, the system may receive an indication that the user 202 may be inputting a payment device into his/her mobile wallet and/or online banking interface. In some embodiments, the indication may be received from the mobile wallet. In some embodiments, the indication may be received from the online banking interface. In other embodiments, the indication may be received from the user 202.

Upon receive an indication that the user 202 is adding a payment device to his/her mobile wallet the system may match the inputted payment device with the physical characteristics and/or affinity data stored on the database, as illustrated in block 311. In this way, the system may be able to search the database to find the electronic representation of the payment device that the user 202 is adding to his/her mobile wallet. As such, if the system may be able to find a match, the system may be able to provide the user 202 with an electronic representation of the payment device from the database, as illustrated in block 312. If no match is found, the system may be able to communicate with the payment device suppliers to find and provide an electronic representation of the payment device to the user 202.

Furthermore, the system may also provide affinity data associated with the payment device. In this way, the user 202 may receive products, offers, or the like that are associated with affinity of the payment device. For example, if the user 202 has a payment device that includes a sports team, the user 202 may be able to receive data associated with that affinity, such as music, ring tones, wallpaper, clothing, or the like associated with that sports team.

Finally, as illustrated in block 314, the system may allow the mobile wallet of the user to display the provided electronic representation of the payment device. In this way, the electronic representation of the exact physical characteristics of the payment devices may be supplied to the user's mobile device such that the user 202 may be able to visualize the payment device in his/her mobile wallet or online banking interface, such that the electronic representation on the mobile wallet or online banking interface may be the same or similar to the actual payment device.

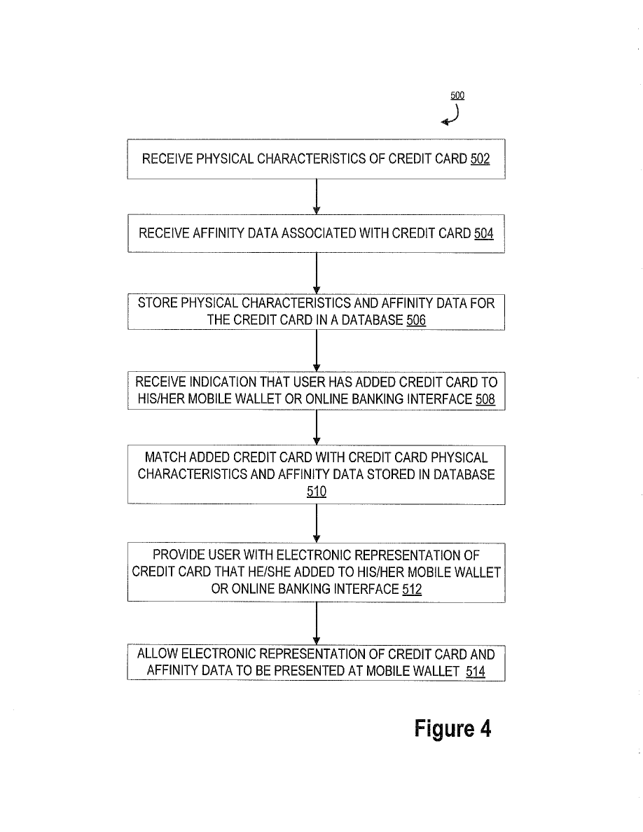

FIG. 4 illustrates a process map of providing electronic rendering of credit cards at a mobile wallet 500, in accordance with one embodiment of the present invention. As illustrated in block 502, the system may communicate with the various payment device suppliers to provide the physical characteristics associated with a credit card. For example, if the credit card has logos, account numbers, a magnetic strip, specific color patterns, or the like, the payment device supplier may sent the system an electronic representation of that exact credit card, such that the electronic representation of the credit card may match the logos, account numbers, a magnetic strip, specific color patterns, or the like that are on the actual credit card. In this way, the system may be able to receive an exact electronic representation of the physical credit card.

Some payment devices may have affinity data associated therewith. As such, the system may receive affinity data associated with the credit card if available, as illustrated in block 504. As such, the system may receive affinity data that may be associated with the credit card. The affinity data may include, but is not limited to logos, trademarks, mascots, colors, figures, symbols, or the like associated with the affinity of the credit card. The affinity data may also include ancillary affinity data such as music, theme songs, ring tones, offers, alternative colors, alternative logos, or the like. In this way, the system may also store any affinity data associated with the credit card, such that a user 202 using that credit card may be able to also access various affinity data associated therewith.

Once the system receives the electronic representation of the physical characteristics and/or the affinity data associated with the credit card payment device, the system may, as illustrated in block 506, store the physical characteristics and affinity for the credit card in a database. In this way, the physical characteristics and/or affinity data for the credit card may be stored in a searchable fashion such that the physical characteristics and/or affinity data for the credit card may be found upon searching for that credit card using any identification means. The system may, for example, be able to search the database based on identification means such as names, account numbers, colors, brands, payment device types, or the like.

Next, as illustrated in block 508, the system may receive an indication that the user 202 may be inputting the credit card into his/her mobile wallet and/or his/her online banking interface. In some embodiments, the indication may be received from the mobile wallet. In some embodiments, the indication may be received from the online banking interface. In other embodiments, the indication may be received from the user 202.

Upon receive an indication that the user 202 is adding the credit card to his/her mobile wallet the system may match, as illustrated in block 510, the inputted credit card with the physical characteristics and/or affinity data associated with that credit card stored on the database, which was illustrated in block 506.

As such, if the system may be able to find a match between the inputted credit card from block 508 and the stored physical characteristics and affinity data from block 506, the system may be able to provide the user 202 with an electronic representation of the credit card from the database, as illustrated in block 512. The electronic representation of the credit card from the database may be presented to the user's mobile wallet and/or the user's online banking interface.

Furthermore, the system may also provide affinity data associated with the credit card. In this way, the user 202 may receive products, offers, or the like that are associated with affinity of the credit card. For example, if the user 202 has inputted a credit card that includes a sports team, the user 202 may be able to receive data associated with that affinity, such as music, ring tones, wallpaper, clothing, or the like associated with that sports team.

Finally, as illustrated in block 514, the system may allow the mobile wallet of the user 202 to display the electronic representation of the credit card to the user 202. In this way, the electronic representation of the exact physical characteristics of the credit card may be supplied to the user's mobile device such that the user 202 may be able to visualize the credit card in his/her mobile wallet, such that the electronic representation of the credit card may be the same or similar to the actual credit card the user 202 may have.

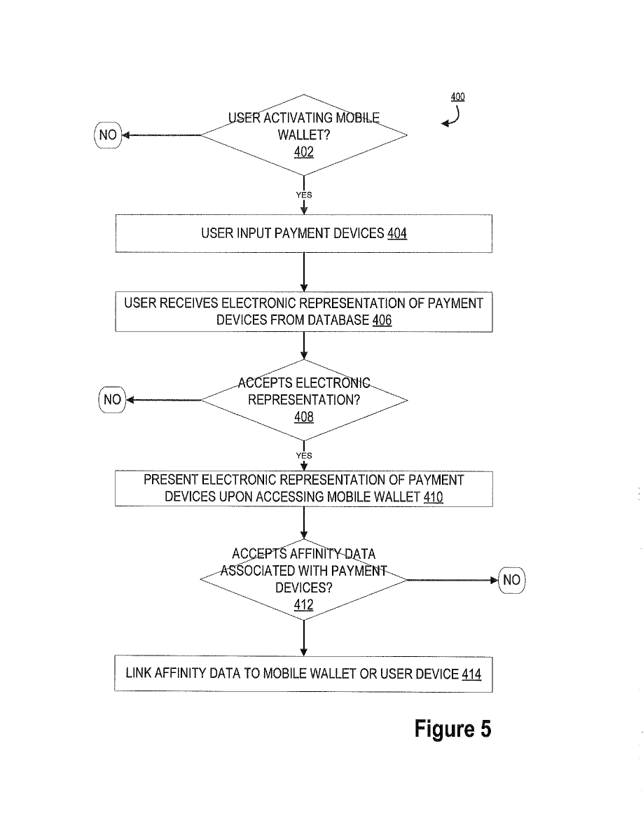

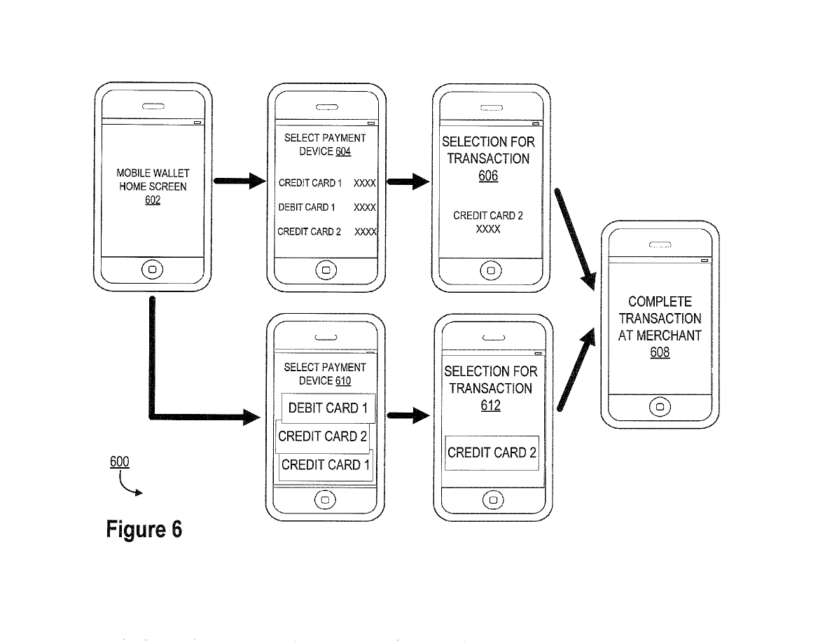

FIG. 5 illustrates a process map of a user 202 process for receiving electronic renderings of payment devices at a mobile wallet 400, in accordance with one embodiment of the present invention. As noted above, one of ordinary skill in the art may appreciated that although FIG. 5 and/or FIG. 6 illustrate electronic renderings of payment devices at a mobile wallet, these electronic renderings may also be presented on a user's online banking interface. First, as illustrated in decision block 402, the user 202 may decide to activate the mobile wallet. If the user 202 does not activate his/her mobile wallet, the process may terminate. If the user 202 does decide to activate his/her mobile wallet, the user 202 may then open his/her mobile wallet. Once the mobile wallet is open and activated, the user 202 may wish to input one or more payment devices into his/her mobile wallet, as illustrated in block 404.

Once the user 202 has inputted a payment device, as illustrated in block 404, the user 202 may then receive an electronic representation of the payment device, as illustrated in block 406. The electronic representation may be provided to the user 202 to his/her mobile wallet from the system. At this point, the user 202 may be able to visualize electronically, the exact physical characteristics of the payment device on his/her mobile wallet. The electronic visualization may allow the user 202 to visualize the physical characteristics of the payment device, such that the user 202 may select the payment device quickly via his/her mobile wallet based on the physical appearance of the payment device.

As illustrated in decision block 408, the user 202 may accept or decline the received electronic representation of the payment device. If the user 202 declines allowing display of the electronic representation of the payment device via the user's mobile wallet, the process is terminated. If, however, the user 202 accepts to allow the display of the electronic representation of the payment device via the user's mobile wallet in decision block 408, the system may present the electronic representation of the payment device upon the user 202 accessing the mobile wallet, as illustrated in block 410.

In some embodiments, the payment device may have associated with it affinity data. As such, as illustrated in block 412, when affinity data is associated with the payment device and available to the user 202, the user 202 may be offered affinity data associated with the payment device. The affinity data available to the user 202 may include, but is not limited to music, theme songs, ring tones, offers, discounts, promotions, clothing, accessories, products, or the like that may be available to the user 202 based on his/her payment device affinity. In some embodiments, the user 202 may decline the affinity data associated with the payment devices. After the user 202 has declined the affinity data, the system may later offer the affinity data to the user 202 or never again offer the user 202 affinity data. As such, the user 202 may be presented with the affinity data at a later time or may not be presented with any affinity data later.

If the user decides to accept the affinity data associated with the payment device, the affinity data may be linked to the mobile wallet and/or user device, as illustrated in block 414. The affinity data that may be linked to or provided to the user 202 may include, but is not limited to music, theme songs, ring tones, offers, discounts, promotions, clothing, accessories, products, or the like that may be available in association with the payment device.

FIG. 6 illustrates an interface for the electronic rendering of payment devices at a mobile wallet 600, in accordance with one embodiment of the present invention. First, as illustrated in 602, the user 202 is presented with his/her mobile wallet home screen. Upon attempting to select a payment device in a standard mobile wallet arrangement, the user 202 may see a select payment device screen 604 that may list the payment devices available to the user 202. For example, the select payment device screen 604 may include the name of the payment device, such as Credit Card 1, Credit Card 2, and/or Debit Card 1 as well as the account numbers associated therewith. Those illustrated as “XXXX” in the screen 604. Next, the user 202 may have selected a payment device and may be presented a confirmation of the selected payment device in the selection for transaction screen 606. In this embodiment, the user 202 has selected Credit Card 2 for selection as the payment device for the transaction. At this point, using the mobile wallet a user 202 may be able to complete the transaction at the merchant, as illustrated in screen 608.

However, if the user 202 has utilized the electronic payment device rendering system, the user 202 upon opening his/her mobile wallet's home screen 602 may next be presented with electronic renderings that include the physical characteristics and/or affinity data associated with the payment devices available on the user's mobile wallet. In this way, the select payment device screen 610 may include accurate electronic representations of the physical characteristics of the payment devices. As such, an illustration of each Debit Card 1, Credit Card 1, and Credit Card 2, in card form may be displayed to the user 202. In this way, the colors, logos, numbers, words, magnetic stripes, chips, or the like associated with the payment device may be displayed in the exact way they would be illustrated on the actual payment device. In this way, the user 202 may be able to visualize an electronic illustration of the payment device on the screen of the mobile wallet. The electronic illustration may be an exact or close there to representation of the actual payment device. This way, the user 202 may be able to quickly visualize the payment devices on the mobile wallet in the same or similar way that the user 202 would when using the actual payment device for a transaction.

Next, the user 202 may have selected a payment device and may be presented a confirmation of the selected payment device in the selection for transaction screen 612. In this embodiment, the user 202 has selected Credit Card 2 for selection as the payment device for the transaction. The electronic representation of Credit Card 2 may be displayed on the selection for transaction screen 612 such that the user 202 may be able to visualize the exact physical representation of the payment device on the screen. At this point, using the mobile wallet a user 202 may be able to complete the transaction at the merchant, as illustrated in screen 608.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing electronic representation of payment devices at a mobile wallet, the system comprising:
a memory device with computer-readable program code stored thereon;
a communication device;
a processing device operatively coupled to the memory device and the communication device, wherein the processing device is configured to execute the computer-readable program code to:
receive an indication that a user is adding a payment device to the mobile wallet, wherein information is received related to the added payment device such that the added payment device can be used for a transaction using the mobile wallet;
identify the added payment device based at least in part on information associated with the added payment device, wherein the information associated with the added payment device is provided by the user to the mobile wallet;
search a payment device database for a match between the added payment device and a payment device on the payment device database, wherein the payment device database comprises stored electronic representation of physical characteristics of payment devices;
determine affinity data associated with the added payment device;
provide the user with the electronic representation of the physical characteristics of the added payment device, such that the electronic representation of the physical characteristics of the added payment device are displayed in association with the mobile wallet; and
provide, upon the determination of affinity data associated with the added payment device, the user with the affinity data.

2. The system of claim 1, wherein providing the user with the affinity data further comprises providing the user with one or more of ring tones, wallpaper, logos, or applications associated with the affinity provided at a user's mobile device.

3. The system of claim 1, wherein providing the user with the affinity data further comprises providing the user with offers and products associated with the affinity, wherein the user receives the affinity data by inputting the payment device associated with the affinity into the mobile wallet.

4. The system of claim 1, wherein the processing device is further configured to establish the payment device database by requesting electronic representations of the physical characteristics of payment devices and affinity data associated therewith from a payment device supplier.

5. The system of claim 1, wherein identifying the payment device being added is based at least in part on information associated with the added payment device provided by the user to the mobile wallet, wherein the information associated with the added payment device includes an account number, name, and expiration date associated with the payment device.

6. The system of claim 1, wherein the processing device is further configured to match the added payment device to stored electronic representation of physical characteristics of payment devices on the payment device database based on the information associated with the added payment device, such that an electronic representation of the physical characteristics of the added payment device is determined.

7. The system of claim 1, wherein if no match between the added payment device and stored electronic representation of physical characteristics of payment devices on the payment device database is identified the processing device can request the electronic representation of the physical characteristics of the added payment device from the payment device supplier.

8. The system of claim 1, wherein the electronic representation of the physical characteristics of the added payment device include representation of one or more of colors, logos, numbers, magnetic strips, or chips associated with the physical appearance of the added payment device, as such the electronic representation of the physical characteristics of the added payment device match the physical appearance of the added payment device.

9. The system of claim 1, wherein determining affinity data associated with the added payment device further comprises determining entities associated with the added payment device that provide one or more incentives to the user for using the added payment device.

10. A computer program product for providing electronic representation of payment devices at a mobile wallet, the computer program product comprising at least one non-transitory computer-readable medium having computer-readable program code portions embodied therein, the computer-readable program code portions comprising:
an executable portion configured for receiving an indication that a user is adding a payment device to the mobile wallet, wherein information is received related to the added payment device such that the added payment device can be used for a transaction using the mobile wallet;
an executable portion configured for identifying the added payment device based at least in part on information associated with the added payment device, wherein the information associated with the added payment device is provided by the user to the mobile wallet;
an executable portion configured for searching a payment device database for a match between the added payment device and a payment device on the payment device database, wherein the payment device database comprises stored electronic representation of physical characteristics of payment devices;
an executable portion configured for determining affinity data associated with the added payment device;
an executable portion configured for providing the user with the electronic representation of the physical characteristics of the added payment device, such that the electronic representation of the physical characteristics of the added payment device are displayed in association with the mobile wallet; and
an executable portion configured for providing, upon the determination of affinity data associated with the added payment device, the user with the affinity data.

11. The computer program product of claim 10, wherein providing the user with the affinity data further comprises providing the user with one or more of ring tones, wallpaper, logos, or applications associated with the affinity provided at a user's mobile device.

12. The computer program product of claim 10, wherein providing the user with the affinity data further comprises providing the user with offers and products associated with the affinity, wherein the user receives the affinity data by inputting the payment device associated with the affinity into the mobile wallet.

13. The computer program product of claim 10, further comprising an executable portion configured to establish the payment device database by requesting electronic representations of the physical characteristics of payment devices and affinity data associated therewith from a payment device supplier.

14. The computer program product of claim 10, wherein identifying the payment device being added is based at least in part on information associated with the added payment device provided by the user to the mobile wallet, wherein the information associated with the added payment device includes an account number, name, and expiration date associated with the payment device.

15. The computer program product of claim 10, further comprising an executable portion configured to match the added payment device to stored electronic representation of physical characteristics of payment devices on the payment device database based on the information associated with the added payment device, such that an electronic representation of the physical characteristics of the added payment device is determined.

16. The computer program product of claim 10, wherein if no match between the added payment device and stored electronic representation of physical characteristics of payment devices on the payment device database is identified the processing device can request the electronic representation of the physical characteristics of the added payment device from the payment device supplier.

17. The computer program product of claim 10, wherein the electronic representation of the physical characteristics of the added payment device include representation of one or more of colors, logos, numbers, magnetic strips, or chips associated with the physical appearance of the added payment device, as such the electronic representation of the physical characteristics of the added payment device match the physical appearance of the added payment device.

18. The computer program product of claim 10, wherein determining affinity data associated with the added payment device further comprises determining entities associated with the added payment device that provide one or more incentives to the user for using the added payment device.

19. A computer-implemented method for providing electronic representation of payment devices at a mobile, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving an indication that a user is adding a payment device to the mobile wallet, wherein information is received related to the added payment device such that the added payment device can be used for a transaction using the mobile wallet;
identifying the added payment device based at least in part on information associated with the added payment device, wherein the information associated with the added payment device is provided by the user to the mobile wallet;
search a payment device database for a match between the added payment device and a payment device on the payment device database, wherein the payment device database comprises stored electronic representation of physical characteristics of payment devices;
determining affinity data associated with the added payment device;
providing, via a computer processing device, the user with the electronic representation of the physical characteristics of the added payment device, such that the electronic representation of the physical characteristics of the added payment device are displayed in association with the mobile wallet; and
providing, upon the determination of affinity data associated with the added payment device, the user with the affinity data.

20. The method of claim 19, wherein providing the user with the affinity data further comprises providing the user with one or more of ring tones, wallpaper, logos, or applications associated with the affinity provided at a user's mobile device.

21. The method of claim 19, wherein providing the user with the affinity data further comprises providing the user with offers and products associated with the affinity, wherein the user receives the affinity data by inputting the payment device associated with the affinity into the mobile wallet.

22. The method of claim 19, further comprising establishing the payment device database by requesting electronic representations of the physical characteristics of payment devices and affinity data associated therewith from a payment device supplier.

23. The method of claim 19, wherein identifying the payment device being added is based at least in part on information associated with the added payment device provided by the user to the mobile wallet, wherein the information associated with the added payment device includes an account number, name, and expiration date associated with the payment device.

24. The method of claim 19, further comprising matching the added payment device to stored electronic representation of physical characteristics of payment devices on the payment device database based on the information associated with the added payment device, such that an electronic representation of the physical characteristics of the added payment device is determined.

25. The method of claim 19, wherein if no match between the added payment device and stored electronic representation of physical characteristics of payment devices on the payment device database is identified the processing device can request the electronic representation of the physical characteristics of the added payment device from the payment device supplier.

26. The method of claim 19, wherein the electronic representation of the physical characteristics of the added payment device include representation of one or more of colors, logos, numbers, magnetic strips, or chips associated with the physical appearance of the added payment device, as such the electronic representation of the physical characteristics of the added payment device match the physical appearance of the added payment device.

27. The method of claim 19, wherein determining affinity data associated with the added payment device further comprises determining entities associated with the added payment device that provide one or more incentives to the user for using the added payment device.
